(19) United States
(12) Patent Application Publication
(10) Pub. No.: US 2004/0238284 A1
(43) Pub. Date: Dec. 2, 2004

(54) Spiral weight transfer motor

(76) Inventor: Arthur James Mathiesen, Hemet, CA (US)

Correspondence Address: Arthur J. Mathiesen, 672 DeSoto Dr., Hemet, CA, 92543, US

(21) Appl. No.: 10/446,024

(22) Filed: May 28, 2003

(51) Int. Cl. F03G 3/00

(52) U.S. Cl. 185/27

(57) ABSTRACT

This unit consist of a spiral unit like a(1) spring,(2) metal balls or bearings, a large (3)wheel or pulley. A pulley (4)belt with cups or holders. A generator with(6) belt. A small(7) motor to turn the(1)spiral or spring. A ball .(8)bearing bottom of spring or spiral. A ball(9) bearing at the top of the spring or spiral to support spring or spiral. A trough (10)or gutter to guide the balls, to the right area at the bottom and a trough (11)or gutter at the top of spring or spiral, to induce the balls to the pulley belt. Also a (12)shaft or rod in and through the spring or spiral to help turn and support the spring or spiral. Also the main(13) stand to hold the(3) large wheel and spring or spiral conveyor. The pulley belt can also be made of chain, the chain can be aluminum, or nylon. It is a very important part of the patent that the pulley belt or chain will hold the balls or bearings.

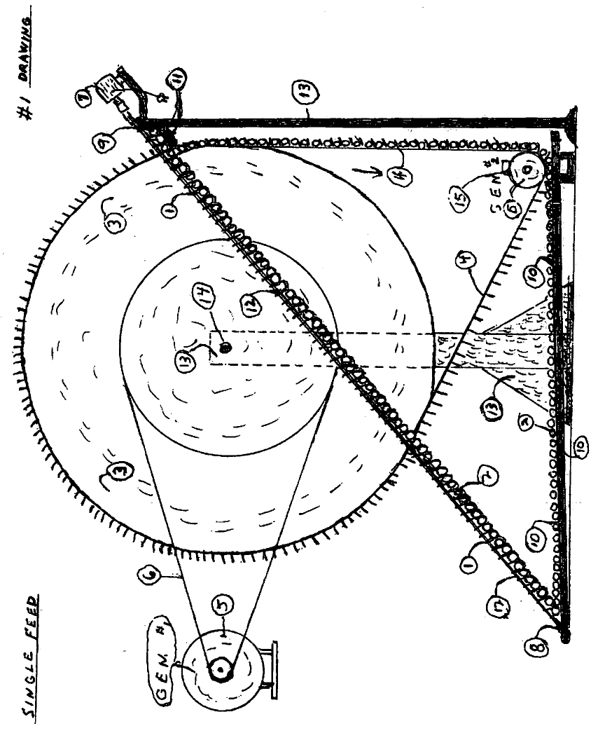

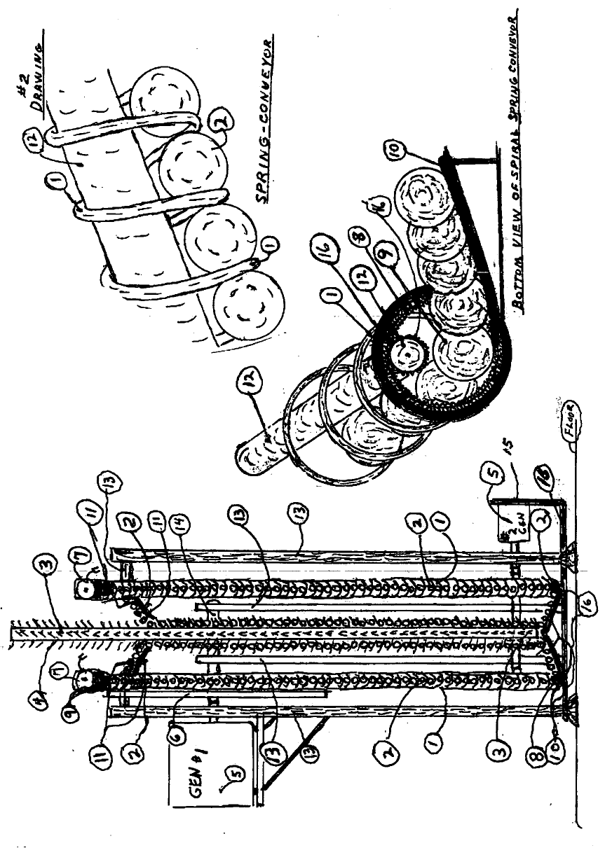

This invention is a very efficient power source, or toy also.

This invention relates to a very efficient conveyor (1)to lift weighted(2)balls to an area, which will induce the balls to a pulley 4)belt on a large wheel. The weighted(2) balls on the pulley(4) belt will add up to a large force to turn the large(3) wheel, which will activate a (5)generator, or to be used for power to turn anything. The spiral(1) or spring conveyor is best used, around 45 degrees

Drawings will show the function of machine or motor.

Drawing #1=Single feed shows, 1 unit, with two generators, but using one generator may be used.

Drawing #2=Double feed is one main wheel #3 with two feeds.

1. Spiral or Spring

2. Metal Balls or Bearings

3. Large Wheel or Pulley

4. Pulley or Belt with Cups

5. Generators

6. Generator Belt

7. Small Motor

8. Ball Bearings at Bottom

9. Ball Bearings at Top

10. Trough or Gutter-Bottom Guide

11. Trough Guide at Top

12. Shaft or Rod Support

13. Main Stand or Support

14. Main Bearing-Wheel

15. Small Generator Support

16. Internal Gear

The patent involves using bearing(8) at the bottom of the spring or spiral, the center open to receive balls or bearings to the inter part of (1)spiral or spring. The (8)bearing at the bottom is one of the main parts, taking most of the weight of the spiral or spring and balls or bearings, making it easy to turn all that weight, Its like standing on a lazy susan, and being turned, the weight is easy to turn.

There is also a (12)shaft or rod that also turns the spiral or spring from top to bottom to keep the spiral or spring straight and strong., also using internal (16) gear.

Also part of the patent is using the(3) large pulley or wheel as a conveyor of weight going down the belt holding weights and falling off at the bottom and returning to the end of the spiral or spring using over and over.

When the spiral(1) or spring conveyor is set about 45 degree and the small motor is turned on the balls induced into the spiral(1), will roll up at very little friction. This small motor(7) will move balls up with very little power. The balls(2) or bearing inside the spiral or spring, fit into the spring as not to touch each other and roll independent with very little friction and once started, the centrifugal force of the balls or bearing, will help in moving the balls or bearing up the spiral or spring.

When the balls(2) or bearing are then induced onto the pulley(4) belt of the large wheel (3), they are automatically held to belt, this weight moves the wheel and belt down the force depends on the number of balls(2) or bearing and their weight on the belt.

At the bottom of the weighted belt the balls or bearing drop off and roll down to the bottom of the spiral or spring and again induced into the spiral or spring, to move up again.

This continued action of balls or bearings moving up at very little power and the balls or bearings coming down at a powerful force to turn another wheel of generator(5) or other power source. This makes this unit a very efficient power source, which is the whole idea of the patent.

1. The use of a (1) spiral spring or spring like unit to be used as a upward conveyor of balls or bearings. As the spiral or spring is turned, the balls or bearings will roll up the spring, the act of rolling will cause much less friction and the centrifugal force will help to move the balls or bearings more efficiently. This spiral or spring conveyor to left weights to a higher platform is claim #1. Balls should not touch, each other inside spring or spiral.

2. From this platform (11) or trough, the balls and bearings will roll onto a pulley belt (4) with holders to catch balls or bearings and attach to the belt(4) of a large pulley. As the wheel or pulley turns the balls will automatically attach to belt going down and detach at the bottom of small wheel. As they drop off into a (10)trough or gutter, they will roll down, into the spiral or spring conveyor.

3. To use a open ball bearing(8) at the bottom of the spiral or spring to be able to induce the balls or bearings to roll inside the spiral or spring. Using the bearing like a lazy susan, with a open center, Bearing also at the top of spiral or spring.(1). Also using internal (16) gear with open bearing(8). The internal gear (16) turns the spring(1) and supporting rod(12).

4. The use of a (3) large pulley wheel, but instead of a water wheel type, the use of a belt with (4)cups or holders and an added small or large pulley at the bottom.
This distance between the inducement of the balls or bearings to the belt, to the lower pulley below, by adding up these weights of balls on pulley or even to hold water, will increase the power of the wheel very much depending on the distance and amount of balls.

5. This type of large(3) pulley at the top and a pulley at the bottom, with a belt that could hold balls or bearings or water or liquids on only one side of the pulley going down could be used in many ways as a power source. Also as a toy.

6. This type of large(3) pulley at the top and a pulley at the bottom(5), using one side only for weights to be used as a generator power source, which is the main idea of patent. That the power to move the weights up is much less than the power of the weights on the Pulley going down hence we call this unit=Spiral Weight Transfer Motor—SWTM—, for liquid or ball bearings.

7. Single feed is when one unit holds on set of balls or bearings or liquids.
Double feed is when one wheel holds two sets of balls or bearings of liquids., will increase efficiency. All balls or bearings should not touch each other to increase efficiency also. It also could be set up for multi sets of ball bearing and wheels. Also many different sizes of the whole units, depending on power needed.
